(19) United States
(12) Patent Application Publication
(10) Pub. No.: US 2013/0236806 A1
(43) Pub. Date: Sep. 12, 2013

(54) INTERCONNECT MEMBER FOR FUEL CELLS

(71) Applicant: ULTRA ELECTRONICS, AMI, ANN ARBOR, MI (US)

(72) Inventors: Aaron Crumm, Ann Arbor, MI (US); Timothy LaBreche, Ann Arbor, MI (US)

(73) Assignee: ULTRA ELECTRONICS, AMI, ANN ARBOR, MI (US)

(21) Appl. No.: 13/871,406

(22) Filed: Apr. 26, 2013

Related U.S. Application Data
(62) Division of application No. 12/698,001, filed on Feb. 1, 2010.
(60) Provisional application No. 61/206,486, filed on Jan. 30, 2009.

(51) Int. Cl. H01M 8/02

(52) U.S. Cl. CPC H01M 8/0202
USPC 429/466

(57) ABSTRACT

A fuel cell system includes a plurality of fuel cell tubes, each fuel cell tube being configured to input fuel at an inlet opening and output exhaust at an exhaust opening. The fuel cell system further includes a current collecting, system comprising an interconnect member disposed through the exhaust opening. The interconnect member electrically connects an inner electrode of a first fuel cell tube to an electrode of a second fuel cell tube.

### CROSS REFERENCE TO RELATED APPLICATIONS

This application is a Divisional of U.S. patent application Ser. No. 12/698,001, filed on Feb. 1, 2010, which claims priority to Provisional Patent Application No. 61/206,486, filed on Jan. 30, 2009, the entire disclosure of which is hereby incorporated by reference and relied upon.

### GOVERNMENT INTERESTS

This invention was made with government support under contract number W909MY-08-C-0025, awarded by the Department of Defense. The government has certain rights in this invention.

### BACKGROUND OF THE INVENTION

1. Field of the Invention

This invention relates to improved electrical current conduction among solid oxide fuel cells.

2. Related Art

A solid oxide fuel cell (SOFC) can react a fuel gas and an oxidant on opposite sides of an electrolyte to generate (“direct current”) DC electric current. SOFCs may have an anode, an electrolyte and a cathode, and can be made from a variety of materials and in a variety of geometries. Solid oxide fuel cell systems can convert hydrocarbon fuels such as butane (C₄H₁₀), propane (C₃H₈), methanol (C₃0H), or liquid fuel (gasoline, diesel fuel, JP-8, or JET-A) to a suitable fuel gas containing carbon monoxide (CO) and hydrogen (H2). CO and hydrogen gas are then oxidized at an active area of a SOFC to carbon dioxide and water, with DC current generated. Non hydrocarbon fuels such as ammonia (NH₃) can also be transformed into SOFC fuel using one or more catalytic reactions.

Current collectors are used on known SOFCs to collect electric current generated by the solid oxide fuel cells. The operating environment of the fuel cell current collector includes high temperature oxidative environments, high temperature reducing environments, and combustion environments. The operating temperatures at the anode and cathode of the fuel cell are in the range of about 600-950° C. The operating temperature at a flame tip region proximate an exhaust outlet of the solid oxide fuel cell can include temperatures of 1000° C. and above.

Known current collectors used in tube-shaped SOFC designs include the so-called “Westinghouse” design where a strip of a lanthanum-chromite ceramic runs along the length of the fuel cell, and a nickel felt electrically connects an electrode of one tube to an electrode of another tube. This design is disadvantageous for several reasons, including the high expense of the nickel felt, the low mechanical strength of the nickel felt joint, thermal expansion mismatch between the nickel felt and other fuel cell materials, and low flexibility in positioning the fuel cells to address heat dissipation and reactant concerns. Portable fuel cell designs can be subject to physical stresses and shocks, etc., and low strength, brittle materials are ill suited for such use.

It has also been known to use silver wires as current collectors, as they are capable of operating in high temperatures and are resistant to oxidation. However, silver wires can be degraded in the high temperature oxidative and reducing environments of the flame tip. It would be desirable to provide a solid oxide fuel cell with a current collector capable of efficiently conducting current while withstanding thermal cycling and physical stresses within the reducing and oxidizing SOFC environment.

### SUMMARY OF THE INVENTION

A fuel cell system including a plurality of fuel cell tubes, each fuel cell tube being configured to input fuel at an inlet opening and output exhaust at an exhaust opening. The fuel cell system further includes a current collecting system comprising an interconnect member disposed through the exhaust opening. The interconnect member electrically connects an inner electrode of a first fuel cell tube to an electrode of a second fuel cell.

### BRIEF DESCRIPTION OF THE DRAWINGS

These and other features and advantages of the present invention will become more readily appreciated when considered in connection with the following detailed description and appended drawings, wherein:

FIG. 1 is a schematic diagram depicting a fuel cell system in accordance with an exemplary embodiment of the present disclosure;

FIG. 2 is a top view of a portion of a fuel cell stack of the fuel cell system of FIG. 1;

FIGS. 3 and 4 depict a prospective view of a plurality of fuel cells and a current collecting system of the fuel cell stack of FIG. 2;

FIG. 5 depicts a cross sectional view of a portion of the current collecting system and a fuel cell of the plurality of fuel cells of FIG. 4;

FIG. 6 depicts a prospective view of the current collecting system of FIG. 4;

FIGS. 7-10 depict prospective views of current collecting systems in accordance with exemplary embodiments of the present disclosure;

FIGS. 11-12 show cross-sectional views of current collecting systems in accordance with the exemplary embodiment of the present disclosure; and

FIG. 13 depicts cross-sectional views of a current collecting system in accordance with an exemplary embodiment of the present disclosure.

### DETAILED DESCRIPTION OF THE PREFERRED EMBODIMENT

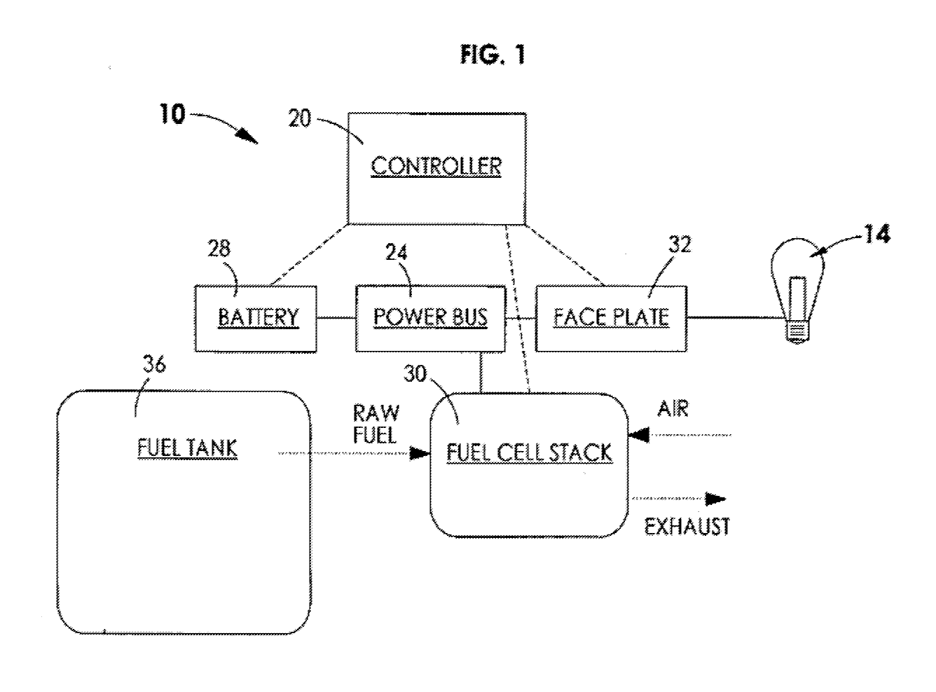

Referring to the figures wherein like numerals indicate like or corresponding parts throughout the several views, FIG. 1 depicts a fuel cell system 10 electrically coupled to an external device 14. The fuel cell system 10 includes a controller (‘CONTROLLER’) 20, a power bus (‘POWER BUS’) 24, a battery (‘BATTERY’) 28, a fuel cell stack (‘FUEL CELL STACK’) 30, a face plate (‘FACE PLATE) 32, and a fuel tank (‘FUEL TANK’) 36.

The controller 20 comprises a general-purpose digital computer comprising a microprocessor or central processing unit, storage mediums comprising non-volatile memory, a high speed clock, analog-to-digital conversion circuitry, input/output circuitry and devices, and appropriate signal conditioning and buffer circuitry. The controller 20 can execute a set of algorithms comprising resident program instructions to monitor control signals from sensors disposed throughout the fuel cell system 10 and can execute algorithms in response to the monitored inputs to execute diagnostic routines to monitor power flows and component operations of the fuel cell system 10.

The power bus 24 comprises an electrically conductive network configured to route power from the energy conversion devices (the rechargeable battery 28 and the fuel cell stack 30) to the face plate 32. The face plate 32 comprises a plurality of electrical connection ports for connecting external devices 14 to the fuel cell system 10. The exemplary rechargeable battery 28 is configured to receive power from the power bus 24 and to discharge power to the power bus 24.

The fuel tank 36 contains raw fuel which is provided from the fuel tank 36 to the fuel cell stack 30. Raw fuel, as used herein, refers to fuel prior to being processed by fuel cell stack 30 as described herein below. Exemplary raw fuels include a wide range of hydrocarbon fuels. In an exemplary embodiment, the fuel is a mixture comprising combinations of various component fuel molecules, examples of which include gasoline blends, liquefied natural gas, JP-8 fuel and diesel fuel. In alternative embodiments, the raw fuel can comprise one or more other types of fuels, such as alkane fuels, for example, methane, ethane, propane, butane, pentane, hexane, heptane, octane, and the like, and can include non-linear alkane isomers. Further, other types of hydrocarbon fuel, such as partially and fully saturated hydrocarbons, and oxygenated hydrocarbons, such as alcohols and glycols, can be utilized as raw fuel that can be converted to electrical energy by the fuel cell stack 30.

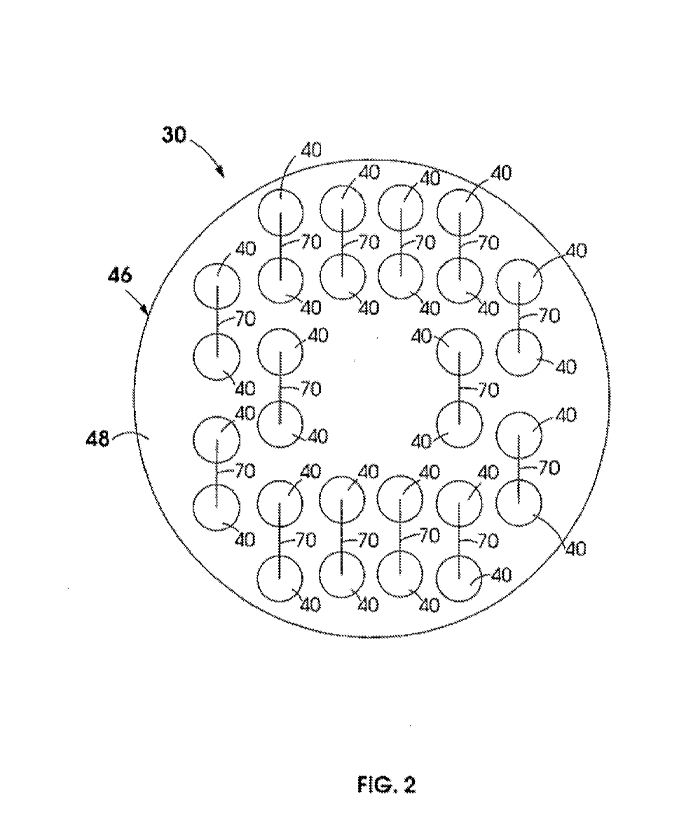

Referring to FIG. 2, the fuel cell stack 30 comprises a plurality of fuel cells 40, and a current collecting system 70, and an insulative body 46. The insulative body 46 defines an insulative cavity 58 and the plurality of the fuel cells 40 are disposed within the insulative cavity 48. Each of the plurality of fuel cell 40 are electrically connected via a current collecting system 70. The insulative body 46 can include a high temperature, ceramic-based material comprising, for example, alumina, silica, and like materials. Atmospheric air is provided to the insulative cavity 48 and is utilized as an oxidant source for reactions on the outer surface of the fuel cells 40. As is explained in further detail below, the fuel cell 40 generates electric current, which can be collected at an electrode disposed at an inner surface of the fuel cell 40 and an electrode disposed at an outer surface of the fuel cell 40.

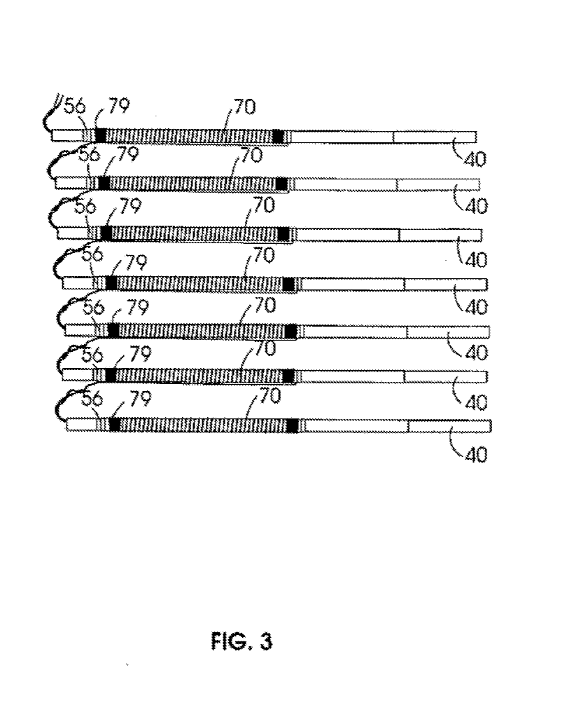

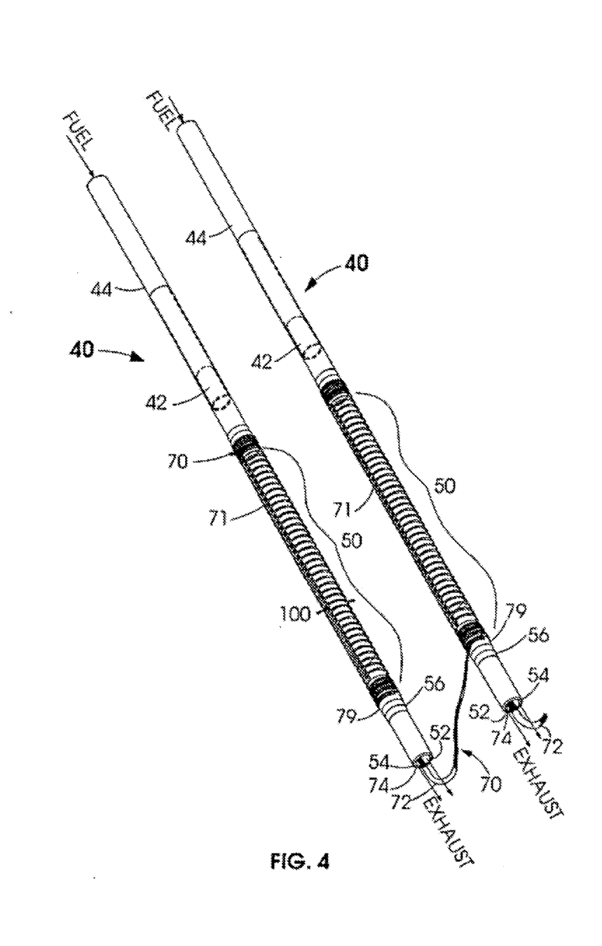

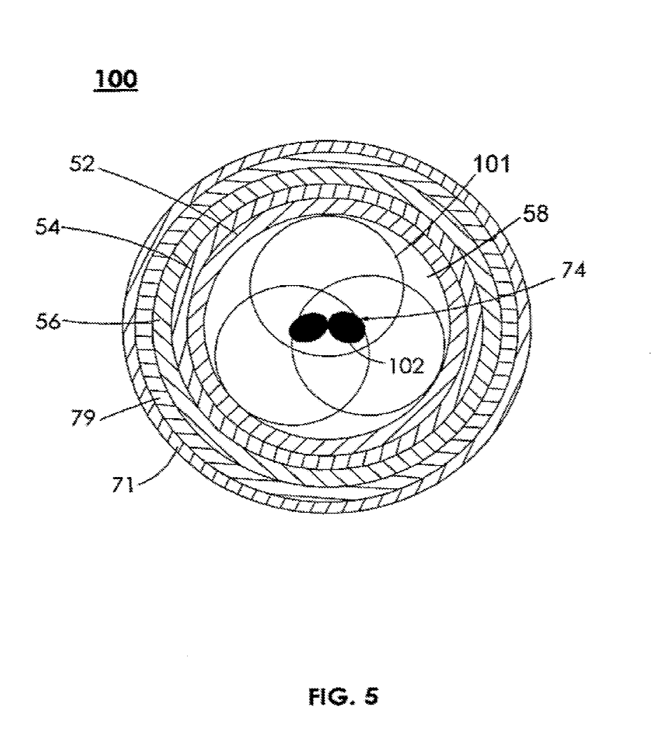

Referring to FIGS. 3-5, FIG. 3 shows the plurality of fuel cells 40 fabricated as a fuel cell belt. FIG. 4 shows electrical connections of the current collecting network 70 between two exemplary fuel cells 40, and FIG. 5 shows as cross-section of fuel cell 40 and conductive network 70 across a plane 100 (depicted in FIG. 4). The plurality of fuel cells 40 fabricated as the fuel cell belt of FIG. 3 represents fuel cells prior to being positioned within the insulative cavity 48. The current collecting system 70 includes an anode current collector 74, an interconnect member 72, and a cathode current collector 71. In an exemplary fuel cell stack 30, the fuel cells are arranged in a series connection of fuel cells 40 producing DC power at a voltage which is a sum of the potential of the individual fuel cells. Alternatively, fuel cell electrodes can be connected in parallel or in a combination with some electrodes connected in series and some electrodes in parallel.

The fuel cells 40 comprise an anode layer 52 and an electrolyte layer 54 on an exterior surface of the anode layer 52. The fuel cells 40 further comprises a cathode layer 56 disposed on a portion of the electrolyte layer 54 to define an active area 50. The active area 50 comprises the portion of the fuel cell 40 at which electromotive force is generated across the electrolyte 54 and current is generated at an active portion of the anode layer 52. Each of the fuel cells 40 further comprise a fuel feed tube 44 having an internal reformer 42 disposed therein.

In an exemplary embodiment, the fuel cells are advantageously relatively light in weight, and provide good power density to mass ratios. As an example of a lightweight design each tube can comprise a 1 mm-20 mm diameter tube. Thin, lightweight tubes are also advantageous in that the tubes hold less heat, allowing the fuel cell to be heated rapidly. An example of a suitable fuel cell tube is disclosed in U.S. Pat. No. 6,749,799 to Crumm et al, entitled METHOD FOR PREPARATION OF SOLID STATE ELECTROCHEMICAL DEVICE and is hereby incorporated by reference. Other material combinations for the anode, electrolyte and cathode, as well as other cross section geometries (triangular, square, polygonal, etc.) will be readily apparent to those skilled in the art given the benefit of this disclosure.

Each fuel cell 40 defines an inner chamber 58 therein and includes openings at a fuel inlet end (‘FUEL’) and an exhaust end (‘EXHAUST’). In an exemplary embodiment., the active area 50 is disposed in closer proximity to the exhaust opening than the fuel inlet opening, so that fuel is routed the length of the fuel cell 40 (and through fuel reforming reactor 42) prior to being provided to the active area 50. In an alternate embodiment comprising an anode layer positioned on an exterior of the fuel cell and a cathode layer positioned on an interior of the fuel cell, a cathode current collector having a substantially similar design to the anode current collector 74 can be disposed within the fuel cell 40.

In general, the anode layer 52 and the cathode layer 56 are formed of porous materials capable of functioning as an electrical conductor and capable of facilitating the appropriate reactions. The porosity Of these materials allows dual directional flow of gases (e.g., to admit the fuel or oxidant gases and permit exit of the byproduct gases). The anode layer 52 comprises an electrically conductive cermet that is chemically stable in a reducing environment. In an exemplary embodiment, the anode comprises a conductive metal such as nickel, disposed within a ceramic skeleton, such as yttria-stabilized zirconia. The cathode layer 56 comprises a conductive material chemically stable in an oxidizing environment. In an exemplary embodiment, the cathode layer 56 comprises a perovskite material and specifically lanthanum strontium cobalt ferrite. In an alternative exemplary embodiment, the cathode layer 56 comprises lanthanum strontium manganite (LSM).

The electrolyte layer 54 comprises a dense layer preventing gas or electron transport, therethrough. Exemplary materials for the electrolyte layer 54 include zirconium-based materials and cerium-based materials such as yttria-stabilized zirconia and gadolinium doped ceria, and can further include various other dopants and modifiers to affect ion conducting properties. The anode layer 52 and the cathode layer 56, which form phase boundaries with the electrolyte layer 54, are disposed on opposite sides of the electrolyte layer 54 with respect to each other.

The fuel reforming reactor 42 is disposed within the fuel feed tube 44 positioned within the inner chamber 48 and spaced upstream (as defined by flow of fuel gas) from and proximate to the active area 50. The fuel feed tube 44 comprises a dense ceramic material such as alumina and zirconia. The fuel reforming reactor 42 reforms hydrocarbon fuel to hydrogen by catalyzing a partial oxidizing reaction between the hydrocarbon and oxygen. In an exemplary embodiment, the fuel reforming reactor 42 comprises a supported catalyst. The supported catalyst includes very fine scale catalyst particles supported on a substrate. Preferably the catalytic substrate is provided with a series of openings Which the fuel gas passes through as the partial oxidation reaction is catalyzed. The fuel reforming reactor 42 can comprise, for example, particles of a suitable metal such as platinum or other noble metals such as palladium, rhodium, iridium, osmium, or their alloys disposed on a substrate which can comprise oxides (such as aluminum oxide), carbides, and nitrides. In other embodiments, the catalytic substrate can include a wire, a porous bulk insert of a catalytically active material, or a thin “ribbon” which having a high surface area to volume ratio or the fuel reforming reactor can comprise a packed bed of catalytic substrate beads. Other materials suitable for use as a catalytic substrate will be readily apparent to those skilled in the art given the benefit of this disclosure. The a fuel feed tube 44 routes hulk fuel flow in a generally uniform direction past the fuel reforming reactor 42 such that substantially all the raw fuel is catalyzed within the fuel reforming reactor prior to contacting the anode layer 52.

The cathode current collector 71 is disposed around the fuel cells 40, preferably at or near the active area 50 to capture electric current generated when the oxidizing gases react at the cathode layer 56. An exemplary cathode current collector 71 comprises at least one wire which has a linear segment extending parallel to the longitudinal axis of the tube and a spiral segment wrapped around the linear segments to maintain contact between the linear segments to the cathode layer 56 and to collect current generated circumferentially at the cathode layer 56. The cathode current collector 71 can comprise, for example, fine gauge wire allowing the wires to be somewhat flexible. A single large gauge wire may be too stiff, as it is advantageous to allow for some play in the fuel cell to absorb energy when subjected to irregular stresses. Irregular stresses and shock loading would be expected with a portable, lightweight solid oxide fuel cell. Further, utilizing flexible wire is advantageous in that provides adaptation manufacturing variability between fuel cells. An example of a suitable wire for use in such cathode current collector is 250 micron silver wire. In other embodiments, the wires of the cathode current collector 71 can comprise high temperature metals or metal alloys having oxidation resistance at 600 to 950° C. examples of which include for example platinum, palladium, gold, silver, iron, nickel and cobalt-based materials. In general, it is desirable to reduce ohmic loss and cathode overpotential. Further, the cathode current collector 71 is electrically conductive (so that electrons generated as a result of the electrochemical reaction of the fuel cell 40 can be collected) and permeable to oxygen (so that oxygen can reach the active area and enter the electrochemical reaction). In an exemplary embodiment, a contact layer 79 is disposed at an interface between the cathode current collector 71 and the cathode layer 56 that functions to reduce ohmic loss and cathode overpotential. In an exemplary embodiment, the contact layer 79 is applied as a layer about 3 to 2.5 microns thick prior to positioning the cathode current collector 71 around the cathode layer 56. In an exemplary embodiment, the contact layer 79 comprises silver palladium. In an alternative embodiment, a contact layer disposed between the cathode and the cathode current collector can comprise perovskite, gold, platinum palladium alloy, and like materials. The cathode current collector 71 is exposed to air (oxygen) and high temperatures, and therefore must maintain high conductivity at these temperatures. In another embodiment, the wires of the cathode current collector 71 can comprise an environmentally protective outer layer and an inner core as described further herein below.

The anode current collector 74 comprises a wire brush having an inner portion 101 and a plurality of loop members 102 extending therefrom. The wire diameters may preferably be set so that the three wires fit snugly inside the tube to promote good electrical contact with that anode while leaving space between the wires for the passage of gas and anode exhaust. The anode current collector 74 comprises an electrically conducting metal. Since the wires are positioned in the processed fuel gas, the anode current collector 74 is formed from material that maintains conductivity in the operating environment of the inner chamber 58. In exemplary inner chamber 58, the oxygen partial pressure, the reducing gas level, and the operating temperature maintain an environment providing sufficiently low rates of copper oxidation such that the anode current collector 74 can comprise copper or a copper alloy.

An anode contact layer (not shown) can physically and electrically connect the anode layer 52 to the anode current collector 74. The anode contact layer is porous to allow the fuel gas to be routed therethrough and can comprise, for example, a paint containing copper or copper oxide which is applied to the anode, and/or the wire or wires of the anode current collector 74 prior to insertion into the inner chamber 58. Upon heating in the fuel gas atmosphere, the copper oxide particles in the paint reduce to copper metal, creating a porous sintered metal contact between the anode current collector and the anode layer 52. Other materials suitable for creating a porous contact include metal oxides such as nickel oxide, which can be brazed or sinter bonded to the anode.

The anode current collector 74 is mechanically compliant relative to the anode 54. The term “mechanically compliant” refers to the ability of the brush portion of the anode current collector 74 to distribute forces created by differing thermal expansion profiles between the anode current collector and the variations in material forming the fuel cell 40 so that the brush portion maintains contact with the anode layer 52. In an alternative embodiment, the loop members 102 of The brush portion can be attached to the anode layer 52 by welding, brazing or sinter bonding.

The interconnect member 72 electrically and physically couples the anode current collector 74 to the cathode current collector 71. In other embodiments, the interconnect member can electrically and physically couple to another anode collector in a parallel configuration. The interconnect member 72 is disposed through the exhaust opening, wherein exhaust from the fuel cell inner chamber 58 comprising unspent fuel comprising one or more fuel species with oxygen containing air disposed outside the fuel cell inner chamber 58. When the heated exhaust stream sufficiently interacts with oxygen, the unspent fuel from the exhaust stream is oxidized in a combustion reaction in a region proximate the exhaust opening known as the flame tip region. The flame tip region comprises an environment with a variable oxidation potential (reducing to oxidative) that is significantly higher than the temperatures present at the anode surface and the cathode surface of the fuel cell 40. Additionally, the interconnect member 72 may act as an electrical lead at a beginning or at an end of a series of fuel cells. The interconnect member 72 may be formed of a conductive material compatible with the thermal and chemical environment can comprise gold, platinum, palladium, noble metals or alloys, and oxidation resistant alloys of iron, nickel or cobalt. In one exemplary embodiment, the interconnect member 72 comprises a gold wire. In an alternate exemplary embodiment, comprises a gold-clad wire having a conductive metal inner core. Exemplary metals for the conductive metal inner core include silver, copper, nickel, iron, and cobalt along with alloys comprising at least one of the foregoing metals.

In another embodiment, the wires of the cathode current collector 71, the anode current collector 74, and the interconnect member 72 can comprise an environmentally protective outer layer and an inner core as described further herein below.

As shown in FIG. 6, each of the anode current collector 74 and the cathode current collector 71 are welded at opposite ends of the interconnect member 72. In particular, in an exemplary embodiment, the anode current collector 74 and the cathode current collector 71 are each brazed or braze-welded, resistive-welded or otherwise joined to the interconnect member 72. In alternative embodiments, the anode current collector 74 and the cathode current collector 71 can be joined to the interconnect member 72 by utilizing other welding or other metal-joining techniques, such as laser, ultrasonic, friction, electron beam, resistance, plasma and other types of metal joining methods. The interconnect portion 74 may also be joined using diffusion bonding, and mechanical forming.

In an exemplary embodiment where the anode current collector 74 is formed of a copper alloy, the anode current collector 74 does not extend outside of the inner chamber 58 such that the anode current collector materials are not oxidized in an oxidative environment outside the inner chamber 58. The interconnect member 72 may also be used as a lead, when utilized in a first or last fuel cell of a series circuit or parallel circuit fuel cell belt. The interconnect member 72 may be the lead extending out of the fuel cell or it may be further connected to a lead wire that extends out of the fuel cell.

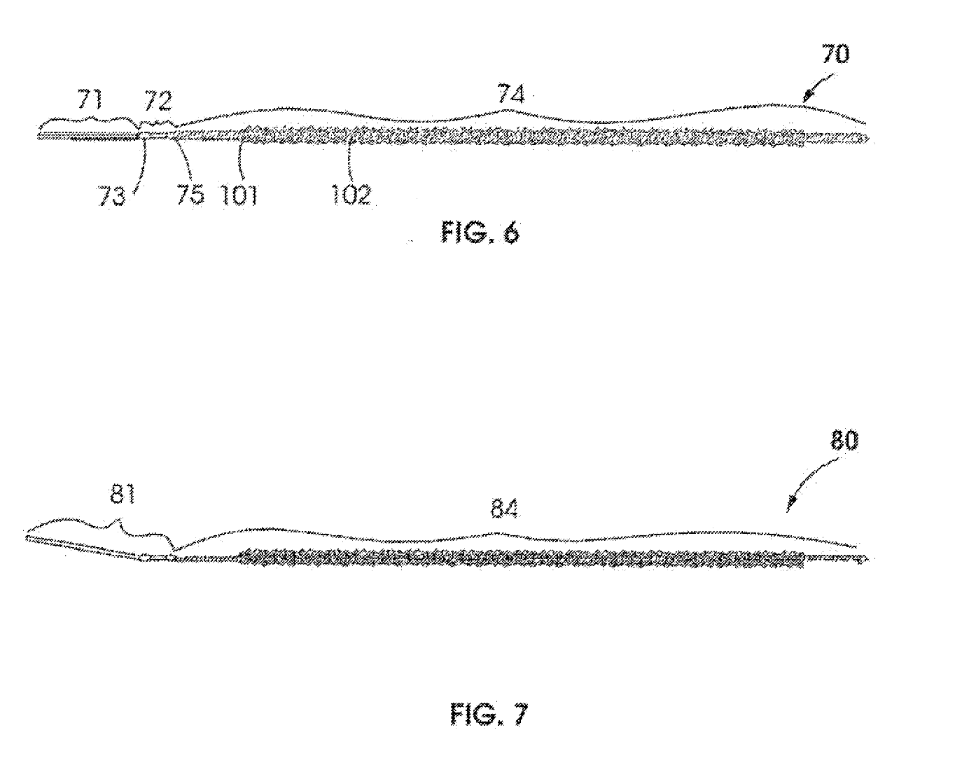

FIGS. 7-10 depict current collecting systems in accordance with alternative embodiments. FIG. 7 depicts a current collecting system 80 comprising an anode current collector 84 as a first segment and a combined interconnect member and cathode current collector 81 as a second segment. The combined interconnect member and cathode current collector 81 comprises a single continuous segment having substantially identical cross-sectional construction throughout its length. The term cross-sectional construction refers to the structure of a wire across a cross-section. Therefore, the term substantially identical cross-sectional constructions refers to layers positioned in substantially similar locations across a cross-section and comprising substantially similar material compositions. In an exemplary embodiment, the anode current collector 84 comprises a substantially similar material composition to the anode current collector 74. Exemplary materials for the combined interconnect member and cathode current collector 81 include silver, gold, platinum, palladium, noble metals or alloys, and oxidation resistant alloys of iron, nickel or cobalt. The material for the combined interconnect member and cathode current collector 81 can be chosen to provide electric current conduction in the atmosphere proximate the cathode and in the flame tip region. In one embodiment, the combined interconnect member and anode current collector can comprise an environmentally protective outer layer and an inner core. In one embodiment, the environmentally protective outer layer comprises gold. In one embodiment, the combined interconnect member and anode current collector has an inner core comprising a substantially similar material composition as the cathode current collector.

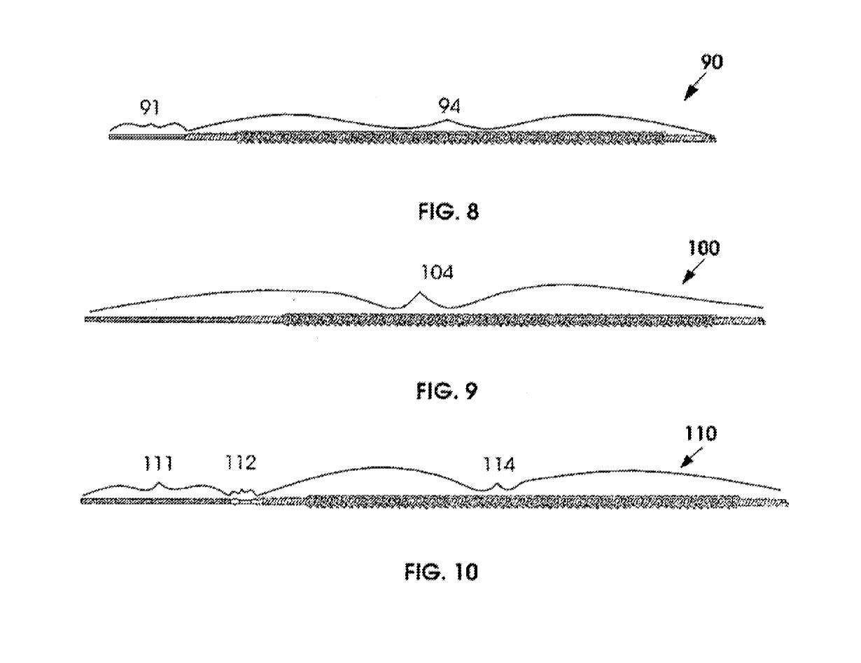

FIG. 8 depicts a current collecting system 90 comprising a cathode current collector 91 as a first segment and a combined interconnect member and cathode current collector 94 as a second segment. The combined interconnect member and anode current collector 94 comprise a single continuous segment having, a substantially identical cross-sectional construction throughout its length. In an exemplary embodiment the cathode current collector 91 comprises a substantially similar material composition to the cathode current collector 71. The combined interconnect member and anode current collector 94 is radially conductive. Exemplary materials for the combined interconnect member and anode current collector 94 include silver, gold, platinum, palladium, noble metals or alloys, and oxidation resistant alloys of iron, nickel or cobalt. The material for the combined interconnect member and anode current collector 94 can be chosen to provide electric current conduction in the atmosphere proximate the anode and in the flame tip region. In one embodiment, the combined interconnect member and anode current collector 94 can comprise an environmentally protective outer layer and an inner core.

FIG. 9 depicts a current collecting system 109 comprising a combined anode current collector, interconnect member and cathode current collector 104 as a continuous segment. The combined anode current collector, interconnect member and cathode current collector member 104 comprise a single continuous segment having a substantially identical cross-sectional construction throughout its length. Exemplary materials for the combined anode current collector, interconnect member and cathode current collector 104 include silver, gold, platinum, palladium, noble metals or alloys, and oxidation resistant alloys of iron, nickel or cobalt. The material for the combined anode current collector, interconnect member and cathode current collector 104 can be chosen to provide electric current conduction in the atmosphere proximate the cathode, the atmosphere proximate the anode, and in the flame tip region. In one embodiment, the combined anode current collector, interconnect member and cathode current collector 104 can comprise an environmentally protective outer layer and an inner core.

FIG. 10 depicts a current collecting system 110 comprising a cathode current collector 111, an interconnect member 112, and an anode current collector 114. The anode current collector 114 and cathode current collector 111 comprises a substantially identical cross-sectional construction. Exemplary materials for the anode current collector 114 and cathode current collector 111 include gold, platinum, palladium, noble metals or alloys, and oxidation resistant alloys of iron, nickel or cobalt. The material for the anode current collector and cathode current collector 111 can be chosen to provide electric current conduction in the atmosphere proximate the cathode and proximate to the anode. In one embodiment, the environmentally protective outer layer comprises gold. In one embodiment, the combined anode current collector, interconnect member and cathode current collector 111 can comprise an environmentally protective outer layer and an inner core. In one embodiment the interconnect member 112 comprises an environmentally protective outer layer comprising gold and the inner core comprises a substantially similar cross-sectional construction to the anode current collector and the cathode current collector.

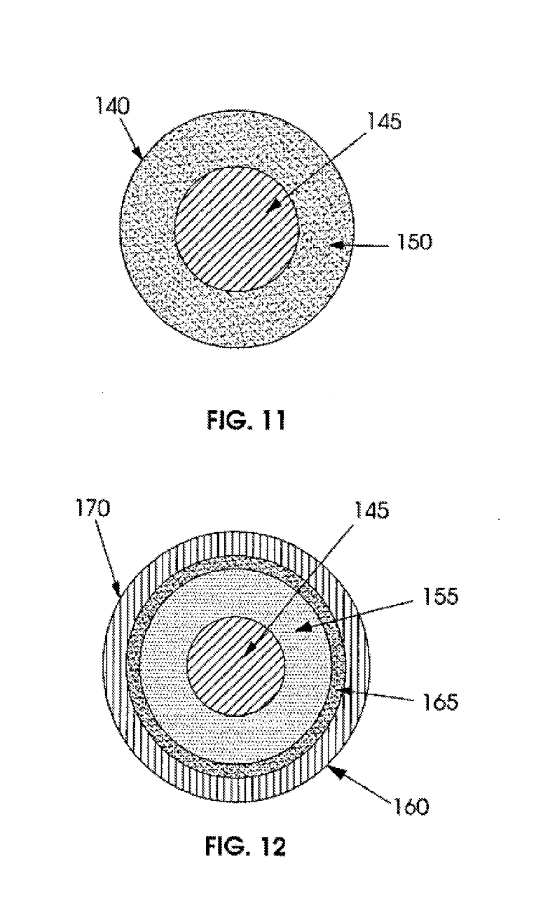

Wire utilized for current collection systems such as the current collection system 70 can comprise any one of a variety of cross-sectional constructions. FIG. 11 depicts an exemplary cross-sectional construction of a wire 140 that can be utilized in a current collecting system in an exemplary embodiment of the present disclosure. The wire 140 comprises a central core 145 comprising an electrically conductive material, for example copper, and an outer layer 150 comprising an environmentally insulative material, for example, stainless steel.

FIG. 12 depicts and exemplary form factor of a wire 170 that can be utilized in a current collection system in accordance with an exemplary embodiment of the present disclosure. The wire 170 comprises a central core 145 comprising conductive material, an outer layer 160 comprising an environmentally protective barrier and intermediate layers 155 and 165 that can provide environmental protection and material compatibility between the outer layer 160 and the central core 145.

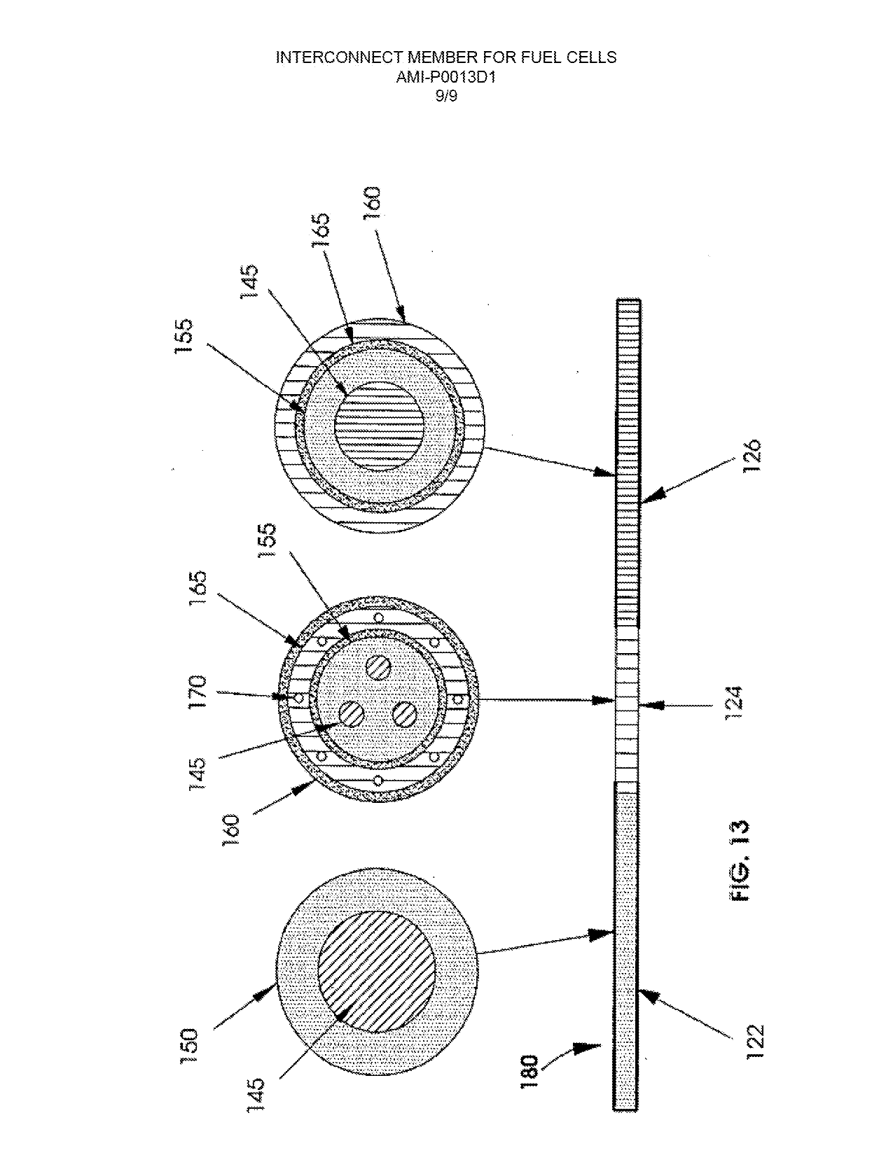

FIG. 13 shows a portion of a wire 180 that can be utilized in a current collection system in accordance with an exemplary embodiment of the present disclosure. The wire 180 includes an anode current collector 122, an interconnect 124, and a cathode current collector 126.

The three central wires are contained within a highly conductive matrix acting as an intermediate layer 145. An additional layer 165 having a material that provides a barrier to chemical reaction and alloying may be used between the highly conductive matrix material intermediate layer 155 and the environmental tolerant layer acting as the outer layer 160. Another additional layer 165 including an environmental barrier may also be present. The additional layer 165 may include an array of secondary structures 170 to enhance the ultimate tensile strength of the wire. The outer layer 160 may act as a bonding layer. For a further description of interconnect system wire form factors refer to U.S. patent application Ser. No. 12/044,355 entitled CLAD COPPER WIRE HAVING ENVIRONMENTALLY ISOLATING ALLOY, which is hereby incorporated by reference.

Since the current collecting systems in accordance with exemplary embodiments are designed to be disposed through a flame tip region, the current collecting systems can comprise a short length and can thereby experience less resistive loss than prior art solid oxide fuel cell current collecting systems.

Although exemplary embodiments are shown herein current collection systems have one, two, and three segments, in other embodiments, the current collection system can have more than three segments. Further, exemplary embodiments shown herein, depict current collectors having a substantially circular cross sections. In other embodiments, the current collector can have various cross sectional geometries, for example, ovals, polygons, flattened or otherwise distorted shapes, irregular shapes, and the like. Further the current collectors can comprise multiples wires and can comprise various other shapes, for example the wire can have various twists, bends, kinks, and loops.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A fuel cell system comprising:
first and second fuel cell tubes, each of said first and second fuel cell tubes being configured to input fuel at a respective inlet opening and output exhaust at a respective exhaust opening, each of said first and second fuel cell tubes including an inner electrode and an outer electrode disposed on opposite sides of an electrolyte, said inner and outer electrodes configured as one of an anode electrode and the other a cathode electrode, and
a current collecting system, said current collecting system including an anode current collector disposed in electrically conductive relationship with said anode electrode of said first fuel cell, said current collecting system including a cathode current collector (104) disposed in electrically conductive relationship with said cathode electrode of said second fuel cell, said current collecting system further including an interconnect member disposed in direct electrical conducting relationship between said anode current collector and said cathode current collector (104), said interconnect member extending through said exhaust opening, said interconnect member electrically connecting said anode electrode of said first fuel cell to said cathode electrode of said second fuel cell, said interconnect member and said anode current collector and said cathode current collector (104) having a common uninterrupted inner core of electrically conductive material surrounded by a clad layer of an environmentally insulative material.

2. The fuel cell system of claim 1, wherein said interconnect member and said anode current collector and said cathode current collector (104) have a substantially identical cross-sectional construction throughout the length thereof.

3. The fuel cell system of claim 1, wherein said interconnect member conducts electrons between said inner electrode of said first fuel cell tube and said outer electrode of said second fuel cell lube.

4. The fuel cell system of claim 1, wherein said interconnect member conducts electrons between said inner electrode of said first fuel cell and said inner electrode of said second fuel cell.

5. The fuel cell system of claim 1, wherein said inner electrode and said outer electrode define an active area for ion conduction, and wherein said active area is positioned adjacent to said exhaust opening of said fuel cell tube.

6. The fuel cell system of claim 1, wherein said clad layer comprises stainless steel and said inner core comprises copper.

7. The fuel cell system of claim 1, wherein said interconnect member is fabricated from an alloy comprising at least one of an iron alloy, a nickel alloy, and a cobalt alloy.

8. The fuel cell system of claim 1, wherein said anode current collector comprises one of copper and silver and nickel, said interconnect member comprises one of gold and platinum and palladium, and said cathode current collector (104) comprises one of silver and stainless steel and gold.

9. The fuel cell system of claim 1, wherein said fuel cell tube is configured to convert the fuel source to power at an operating temperature of between 600° C. and 1,000° C.

10. A fuel cell system comprising:
first and second fuel cell tubes, each of said first and second fuel cell tubes being configured to input fuel at a respective inlet opening and output exhaust at a respective exhaust opening, each of said first and second fuel cell tubes including an inner electrode and an outer electrode disposed on opposite sides of an electrolyte, said inner and outer electrodes configured as one of an anode electrode and the other a cathode electrode, and
a current collecting system, said current collecting system including an anode current collector disposed in electrically conductive relationship with said anode electrode of said first fuel cell, said current collecting system including a cathode current collector (104) disposed in electrically conductive relationship with said cathode electrode of said second fuel cell, said current collecting system further including an interconnect member disposed in direct electrical conducting relationship between said anode current collector and said cathode current collector (104), said interconnect member extending through said exhaust opening, said interconnect member electrically connecting said anode electrode of said first fuel cell to said cathode electrode of said second fuel cell, said interconnect member and said anode current collector and said cathode current collector (104) having a substantially identical cross-sectional construction throughout the length thereof.

11. The fuel cell system of claim 10, wherein said interconnect member and said anode current collector and said cathode current collector (104) have a common uninterrupted inner core of electrically conductive material surrounded by a clad layer of an environmentally insulative material.

12. The fuel cell system of claim 10, wherein said interconnect member conducts electrons between said inner electrode of said first fuel cell tube and said outer electrode of said second fuel cell tube.

13. The fuel cell system of claim 10, wherein said interconnect member conducts electrons between said inner electrode of said first fuel cell and said inner electrode of said second fuel cell.

14. The fuel cell system of claim 10, wherein said inner electrode and said outer electrode define an active area for ion conduction, and wherein said active area is positioned adjacent to said exhaust opening of said fuel cell tube.

15. The fuel cell system of claim 10, wherein said clad layer comprises stainless steel and said inner core comprises copper.

16. The fuel cell system of claim 10, wherein said interconnect member is fabricated from an alloy comprising at least one of an iron alloy, a nickel alloy, and a cobalt alloy.

17. The fuel cell system of claim 10, wherein said anode current collector comprises one of copper and silver and nickel, said interconnect member comprises one of gold and platinum and palladium, and said cathode current collector (104) comprises one of silver and stainless steel and gold.

18. The fuel cell system of claim 10, wherein said fuel cell tube is configured to convert the fuel source to power at an operating temperature of between 600° C. and 1,000° C.

19. A fuel cell system comprising:
first and second fuel cell tubes, each of said first and second fuel cell tubes being configured to input fuel at a respective inlet opening and output exhaust at a respective exhaust opening, each of said first and second fuel cell tubes including an inner electrode and an outer electrode disposed on opposite sides of an electrolyte, said inner and outer electrodes configured as one of an anode electrode and the other a cathode electrode, and
a current collecting system, said current collecting system including an anode current collector disposed in electrically conductive relationship with said anode electrode of said first fuel cell, said current collecting system including a cathode current collector (104) disposed in electrically conductive relationship with said cathode electrode of said second fuel cell, said current collecting system further including an interconnect member disposed in direct electrical conducting relationship between said anode current collector and said cathode current collector (104), said interconnect member extending through said exhaust opening, said interconnect member electrically connecting said anode electrode of said first fuel cell to said cathode electrode of said second fuel cell, said interconnect member and said anode current collector and said cathode current collector (104) having a common uninterrupted inner core of electrically conductive material surrounded by a clad layer of an environmentally insulative material, and said interconnect member and said anode current collector and said cathode current collector (104) further having a substantially identical cross-sectional construction throughout the length thereof.

20. The fuel cell system of claim 19, wherein said anode current collector comprises one of copper and silver and nickel, said interconnect member comprises one of gold and platinum and palladium, and said cathode current collector (104) comprises one of silver and stainless steel and gold.
